(19) United States
(12) Patent Application Publication
(10) Pub. No.: US 2006/0217122 A1
(43) Pub. Date: Sep. 28, 2006

(54) Methods for interactive, real-time adjustments of antenna and other network state elements in a wireless network

(75) Inventors: Itzhak Levit, Alameda, CA (US); Marc Bensadoun, Berkeley, CA (US)

Correspondence Address: FLIESLER MEYER, LLP, FOUR EMBARCADERO CENTER, SUITE 400, SAN FRANCISCO, CA, 94111, US

(73) Assignee: Newfield Wireless, Inc., Berkeley, CA (US)

(21) Appl. No.: 11/384,557

(22) Filed: Mar. 20, 2006

Related U.S. Application Data
(60) Provisional application No. 60/663,979, filed on Mar. 22, 2005.

(51) Int. Cl. H04Q 7/20

(52) U.S. Cl. 455/446

(57) ABSTRACT

Methods for interactively adjusting antennas and displaying network state elements in a simulated wireless network with real-time calculation and a complete display of the effect of the modification on the network performance. The result is an intuitive and efficient way of maintaining a wireless network that replaces a common multi-step, time consuming and tedious operation of network maintenance, by a single step operation that is performed in real time.

### CLAIM OF PRIORITY

U.S. Provisional Patent Application No. 60/663,979 entitled Methods for Interactive, Real-time Adjustments of Antenna and Other Network State Elements in a Wireless Network, by Itzhak Levit et al., filed Mar. 22, 2005.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

This invention relates to the field of wireless networks and the adjustments of antenna and other network state elements.

### BACKGROUND OF THE INVENTION

Wireless network adjustment is a routine operation performed daily by wireless network operators to design a new wireless network or to optimize an existing network. Changes are made for many reasons including the need to improve coverage, quality of service, and capacity. These changes are necessitated by many factors, including: performance issues from customer complaints, field test data, switch or other network operational measurement; changing antenna setting requirements or constraints, including zoning, leasing or structural changes; increasing or shifting usage including movement of high usage areas. The network engineers are required to change antenna parameters to compensate for the change in the environment parameters and to increase the capacity, coverage, and quality of service offered to their customers.

Antenna parameters may include any combination of: antenna discrimination pattern, either by changing the antenna model or adjusting the discrimination parameters of an adjustable antenna, azimuth, mechanical down-tilt, electrical down-tilt, and twist, power, and changes in antenna height.

Currently, wireless network engineers use a radio-frequency (RF) planning tool for determining the required changes. For each network change, the engineer is required to perform multiple steps manually recording his change in various configuration dialogs/tables, performing several network analysis steps, and finally, generation and examination of results that will indicate if the change yielded the desired result.

The above process is time consuming and tedious, which results in less than optimal network changes and reluctance to utilize the full potential of available predictive tools.

### SUMMARY OF THE INVENTION

The invention consists of approaches to perform wireless network tuning in a single step and in real-time using an intuitive interface that clearly shows the network engineer a complete picture of the effect on the network of his changes to antenna parameters.

The invention consists of configurable, simultaneous presentations of the network state using a combination of multiple area maps of various quantities of importance to the engineer, graphs and scalar measures of quantities that are of importance to the engineer and a set of controls that enables the engineer to quickly and intuitively change antenna parameters in a single-step fashion.

The invention enables a network engineer to quickly determine the optimal setting of any of the antenna parameters and to be able to experiment and examine many what-if scenarios in the network.

An example of the configurable single-step interface for the antenna tuning is shown in FIG. 1.

### BRIEF DESCRIPTION OF THE DRAWINGS

FIG. 1 is a graphic display showing an example of Single-Step Antenna Adjustments GUI; and

FIG. 2 is a flow diagram for real-time, single-step antenna tuning.

### DETAILED DESCRIPTION OF THE INVENTION

The invention consists of the following components:
1. Configuration—enabling the user to select maps, graphs and scalar values to display for monitoring the effect of an antenna parameter change.
2. Display—showing the configured maps, graphs and scalar values selected by the user for monitoring the antenna changes
3. Antenna parameters control—a set of UI interfaces for displaying and changing the current antenna parameters values.
4. Rapid re-analysis—an algorithm for rapid recalculation of the wireless network state due to a single parameter change that enables a real-time update of the Display.

For an RF network, as examples, maps may include: forward or reverse link received signal strength; forward or reverse link received signal to noise ratio; forward or reverse link traffic channel power or total transmitted power, including mobile transmission power; interference or noise; forward or reverse operational path loss; handoff state, Walsh code, served and unserved users, forward or reverse link noise rise, pole capacity; balancing of: any transmitted or received power, code, channel element, Erlang or any other network element resource across carriers on a sector, sectors on a cell, sectors in an area; service area; dropped calls; forward or reverse re-use factors; any derivative of the above quantities, including power-per-Erlang ratio; infrastructure cost, including costs of capital or operational expenses associated with cell sites, backhaul, switching or other network components; and implementation costs including capital or expense costs.

For an RF network, as examples, graphs may include: scatter plots or histograms of any of the quantities in the preceding paragraph, including any quality of service measure.

For an RF network, as examples, scalar quantities may include: any of the quantities in the preceding paragraphs, including service area, served users, dropped calls, load balancing measure, and integrated cost components for coverage and capacity.

As examples, the invention may employ one or more of the following user interfaces for changing antenna parameters (azimuth, mechanical down tilt and twist, height, electrical down-tilt, pilot power, antenna model, and all antenna discrimination footprint parameters): text input, sliders, dialers, up/down buttons, up/down assigned keyboard keys, pointing device button click, up/down assigned pointing device motion. For antenna model change, the invention uses a selectable antenna list.

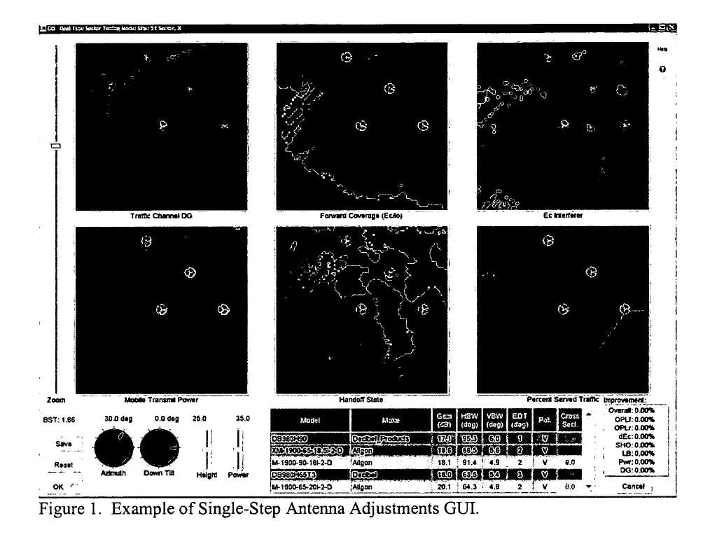

An example of a configured display, according to embodiments of the invention, is shown in FIG. 1 where six maps are used as well as variety of scalar quantities give a complete state of the network in a single display. Dialers are used for changing the antenna azimuth and mechanical down-tilt angles, sliders are used for changing the antenna height and pilot power and selectable table is used for changing antenna model.

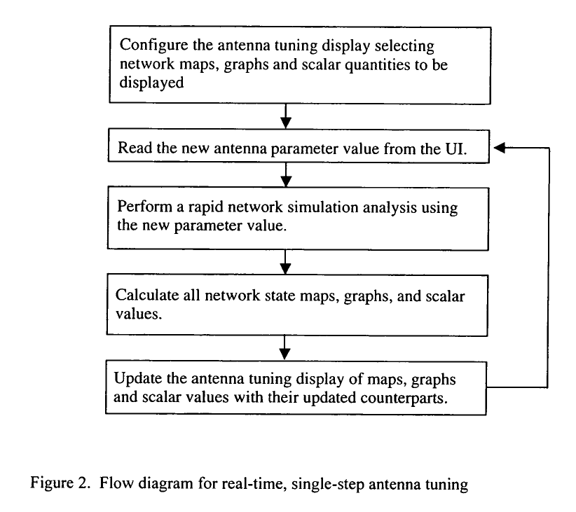

FIG. 2 shows a flow chart of a set of embodiments of the invention, after an initial configuration step in which the user selects the maps, graphs and scalar values that he would like to monitor when changing his antenna parameters, the invention enters a loop each time any of the antenna parameters is modified by the user through the GUI. The loop consists of the following steps:
1. Read the new antenna parameter value.
2. Perform a rapid-reanalysis of the network, to account for the antenna parameter change.
3. Calculate the new network state accounting for the effect of the antenna change on all neighboring antennas.
4. Calculate and update the displayed maps, graphs and scalar value.

This process is repeated in real time as long as the user keeps changing antenna parameters, the user can switch to modifying a different antenna, by simply clicking on the antenna icon in any of the maps windows and can save any intermediate configuration of his network for future use.

What is claimed is:

1. A method for interactive, real-time adjustment of antennas and displaying network state elements in a wireless network, comprising the steps of:
a) providing a graphical user interface (GUI) capable of displaying one or more network state elements in a wireless network comprising one or more antennas, wherein each said antenna is described by a set of antenna parameters, and wherein a network state element is defined as one of a map of said wireless network, a graph relevant to said wireless network, and a scalar quantity relevant to said wireless network, and wherein said GUI is further capable of displaying current user-specified values of antenna parameters describing a selected antenna;
b) receiving the currently displayed set of antenna parameters describing the selected antenna;
c) performing a rapid network simulation analysis using said set of current antenna parameters;
d) using results of said network simulation analysis, calculating the current values of all said network state elements; and
e) displaying said current values on said GUI.

2. The method of claim 1, wherein said wireless network is a radio frequency (RF) wireless network.

3. The method of claim 1, wherein steps b) through e) are repeated one or more times.

4. The method of claim 3, wherein said selected antenna is the same antenna throughout the operation of the invention.

5. The method of claim 3, wherein said selected antenna is changed at least once during the operation of the invention.

6. The method of claim 1, wherein a set of values of network state elements can be saved by said user.

7. The method of claim 1, wherein at least one said map maps forward link-received signal strength.

8. The method of claim 1, wherein at least one said map maps reverse link-received signal strength.

9. The method of claim 1, wherein at least one map maps forward link-received signal to noise ratio.

10. The method of claim 1, wherein at least one map maps reverse link-received signal to noise ratio.

11. The method of claim 1, wherein at least one map maps forward link traffic channel power.

12. The method of claim 1, wherein at least one map maps reverse link traffic channel power.

13. The method of claim 1, wherein at least one map maps total transmitted power.

14. The method of claim 13, wherein said total transmitted power comprises mobile transmission power.

15. The method of claim 1, wherein at least one map maps interference.

16. The method of claim 1, wherein at least one map maps noise.

17. The method of claim 1, wherein at least one map maps forward operational path loss.

18. The method of claim 1, wherein at least one map maps reverse operational path loss.

19. The method of claim 1, wherein at least one map maps handoff state.

20. The method of claim 1, wherein at least one map maps Walsh code across one of carriers on a sector, sectors on a cell, and sectors in an area.

21. The method of claim 1, wherein at least one map maps served users across one of carriers on a sector, sectors on a cell, and sectors in an area.

22. The method of claim 1, wherein at least one map maps unserved users across one of carriers on a sector, sectors on a cell, and sectors in an area.

23. The method of claim 1, wherein at least one map maps forward link noise rise across one of carriers on a sector, sectors on a cell, and sectors in an area.

24. The method of claim 1, wherein at least one map maps reverse link noise rise across one of carriers on a sector, sectors on a cell, and sectors in an area.

25. The method of claim 1, wherein at least one map maps pole capacity across one of carriers on a sector, sectors on a cell, and sectors in an area.

26. The method of claim 1, wherein at least one map maps balancing of transmitted power across one of carriers on a sector, sectors on a cell, and sectors in an area.

27. The method of claim 1, wherein at least one map maps balancing of received power across one of carriers on a sector, sectors on a cell, and sectors in an area.

28. The method of claim 1, wherein at least one map maps balancing of code across one of carriers on a sector, sectors on a cell, and sectors in an area.

29. The method of claim 1, wherein at least one map maps balancing of channel power across one of carriers on a sector, sectors on a cell, and sectors in an area.

30. The method of claim 1, wherein at least one map maps balancing of total traffic across one of carriers on a sector, sectors on a cell, and sectors in an area.

31. The method of claim 30, wherein total traffic is computed in Erlangs.

32. The method of claim 1, wherein at least one map maps dropped calls.

33. The method of claim 1, wherein at least one map maps forward re-use factors.

34. The method of claim 1, wherein at least one map maps reverse re-use factors.

35. The method of claim 1, wherein at least one map maps a derivative of one of the quantities mapped in one of claims 2 through 34.

36. The method of claim 1, wherein at least one map maps the power per Erlang.

37. The method of claim 1, wherein at least one map maps infrastructure cost.

38. The method of claim 37, wherein infrastructure cost comprises capital expenses associated with cell sites.

39. The method of claim 37, wherein infrastructure cost comprises operational expenses associated with cell sites.

40. The method of claim 37, wherein infrastructure cost comprises backhaul cost.

41. The method of claim 37, wherein infrastructure cost comprises switching cost.

42. The method of claim 37, wherein infrastructure cost comprises cost of other network components.

43. The method of claim 37, wherein infrastructure cost comprises implementation costs.

44. The method of claim 43, wherein said implementation costs comprise capital costs.

45. The method of claim 43, wherein said implementation costs comprise expense costs.

46. The method of claim 1, wherein at least one graph is a scatter plot of one of the state elements described in one of claims 2 through 45.

47. The method of claim 1, wherein at least one graph is a histogram of one of the state elements described in one of claims 2 through 45.

48. The method of claim 1, wherein at least one scalar quantity is a service area.

49. The method of claim 1, wherein at least one scalar quantity is a number of dropped calls.

50. The method of claim 1, wherein at least one scalar quantity is a load balancing measure.

51. The method of claim 1, wherein at least one scalar quantity is a measure of integrated cost components for coverage.

52. The method of claim 1, wherein at least one scalar quantity is capacity.

53. The method of claim 1, wherein said antenna parameters comprise one or more of azimuth, mechanical down tilt and twist, height, electrical down-tilt, pilot power, antenna model, and antenna discrimination footprint parameters.

54. The method of claim 1, wherein said GUI uses a selectable antenna list to enable said user's selection of an antenna.

55. The method of claim 1, wherein said GUI comprises text input.

56. The method of claim 1, wherein said GUI comprises sliders.

57. The method of claim 1, wherein said GUI comprises up buttons and down buttons.

58. The method of claim 1, wherein said GUI comprises up-assigned keyboard keys and down-assigned keyboard keys.

59. The method of claim 1, wherein said GUI comprises a pointing device button click.

60. The method of claim 1, wherein said GUI comprises an up-assigned pointing device motion and a down-assigned pointing device motion.
